(19) United States
(12) Patent Application Publication
(10) Pub. No.: US 2006/0105174 A1
(43) Pub. Date: May 18, 2006

(54) Optical pH sensor

(75) Inventors: Robert C. Aller, Stony Brook, NY (US); Qingzhi Zhu, Port Jefferson, NY (US)

Correspondence Address: GOODWIN PROCTER LLP, 599 LEXINGTON AVENUE, NEW YORK, NY, 10022, US

(73) Assignee: The Research Foundation of State University of New York

(21) Appl. No.: 11/257,481

(22) Filed: Oct. 24, 2005

Related U.S. Application Data
(63) Continuation-in-part of application No. 10/973,663, filed on Oct. 25, 2004.

(51) Int. Cl. B32B 27/00

(52) U.S. Cl. 428/411.1; 428/500

(57) ABSTRACT

A new stable and reversible planar pH fluorosensor is prepared by conjugating a pH sensitive fluorescent material to a water-soluble polymer chain attached to a support. The invention also provides for a thin-film standard pH apparatus.

### CROSS REFERENCE TO RELATED APPLICATION

This application is a continuation-in-part of U.S. Ser. No. 10/973,663 filed Oct. 25, 2004, which is incorporated by reference herein.

The invention also relates to a thin-film pH standard which can be used for pH calibration in the local environment. Partial funding for the development of this invention was provided by U.S. Government Grant NSF grant OCE0117062. The United States government may own certain rights to this invention.

### BACKGROUND OF THE INVENTION

This invention relates to an optical sensor for measuring pH with improved stability and sensitivity. A pH sensitive fluorescent material is conjugated to a water-soluble polymer chain attached to a support. The water-soluble polymer chain extends away from the support when contacted with an aqueous sample resulting in improved sensitivity for pH measurement.

Fluorescent indicators have been used as an alternative to potentiometric techniques to measure pH. 8-Hydroxyl-1,3,6-pyrenetrisulphonate (HPTS) has been considered one of the best potential indicators for pH determination because of its excellent photo-stability, high quantum yield, dual excitation, large Stokes' shift and long fluorescence emission. An essential feature of this indicator is that the acidic (associated, HPTS) and basic (dissociated, PTS⁻) forms have different excitation wavelengths at 406 and 460 nm, with an isosbestic point at 418 nm, but exhibit a similar fluorescence emission maximum at 515 nm. The dual excitation and single emission make HPTS suitable for ratiometric detection of pH. The fluorescence intensity at 406 nm for the acid form decreases but the intensity at 460 nm for the base form increases as the pH is raised accompanying the conversion of the acidic into basic forms of HPTS. However, when HPTS is directly physically or covalently immobilized in polymer membranes, researchers have found that the fluorescence excitation intensities of both acid and base forms increased along with increasing pH, and that there was no isosbestic point accompanying the conversion between acid and base form. This change results in a lowered sensitivity for ratiometric pH measurements.

### SUMMARY OF THE INVENTION

Accordingly, it is an object of the invention to prepare an optical sensor with high stability and enhanced sensitivity which can be used to determine pH in a sample.

A further object of the invention is to provide an optical sensor which can be used to determine pH in environmental studies of natural waters, sediments, and soils. These and other objects of the invention are achieved by providing an optical sensor including a copolymer having a water soluble portion conjugated to a pyrenetrisulphonate wherein one end of the copolymer is covalently bound to a support. When the sensor is contacted with aqueous solution, the water-soluble portion causes the copolymer to extend or stretch out thereby facilitating contact with the sample. In this manner the immobilized pyrenetrisulphonate exhibits fluorescence properties similar to free pyrenetrisulphonate in solution.

The invention also provides for a method of making an optical sensor comprising conjugating a pyrenetrisulphonyl chloride and a water soluble material to form a conjugate, and copolymerizing the conjugate and an acrylamide wherein a copolymer is formed and wherein one end of the copolymer is attached to a support.

The invention further provides a method of determining the pH of a sample comprising providing an optical sensor foil comprising a transparent support material and a copolymer having a water-soluble porting conjugated to pyrenetrisulphonate wherein the copolymer has one end attached to the transparent support material to form a sensor foil, contacting the sample with the optical sensor foil, obtaining the fluorescence intensity of the sensor foil in the sample, and determining the pH of the sample from a fluorescence intensity ratio.

The relative fluorescence spectra of immobilized HPTS and pH response in this new membrane are similar to those of free HPTS, but actually show higher overall sensitivity to pH compared with free HPTS. The rugged physical properties of this new sensor membrane are also such as to make it particularly desirable for practical use in a variety of applications such as environmental studies of natural waters, sediments, and soil. The use of optodes to measure pH is described in Hulth, S., Aller R., Engstrom P. and Selander E., Limno. Oceanogr., 47 (1), 2002, pp. 212-220 which is incorporated by reference herein.

This invention also relates to a thin-film pH standard apparatus comprising a transparent support material, a film of a pH standard solution, and an optical sensor material having a sensor surface facing the standard solution.

### BRIEF DESCRIPTION OF THE DRAWING

FIG. 1 is a schematic illustration of a process for preparation of an optical sensor in accordance with the invention.

FIG. 2(A) is fluorescence spectra of free HPTS;

FIG. 2(B) is fluorescence spectra of an optical sensor foil in accordance with the invention obtained using seawater buffers;

FIG. 3 is a graph of ratio of fluorescence intensity at 506 nm to that at 428 nm from pH 4 to pH 9 for an optical sensor according to the invention and the ratio of fluorescence intensity at 460 nm over 406 nm for free HPTS; and

FIG. 4 is a schematic illustration of a side view of a thin-film pH standard apparatus in accordance with the invention.

### DETAILED DESCRIPTION OF THE PREFERRED EMBODIMENTS

The sensor of the invention is based on a new immobilization method of HPTS onto a polymer membrane. The traditional immobilization method directly binds or entraps HPTS in a membrane, so the vibration of immobilized HPTS molecules is largely limited. Restricted vibration results in changes of HPTS excitation bands and thus pH response characteristics. In a method according to the invention, a water-soluble single polymer chain is conjugated to HPTS. This soluble polymer chain is then covalently bound to the surface of a rugged insoluble polymer membrane through a co-polymerization procedure. When this kind of membrane is placed into aqueous solution, the water-soluble polymer chains stretch out, and the immobilized HPTS exhibits characteristics very similar to free HPTS.

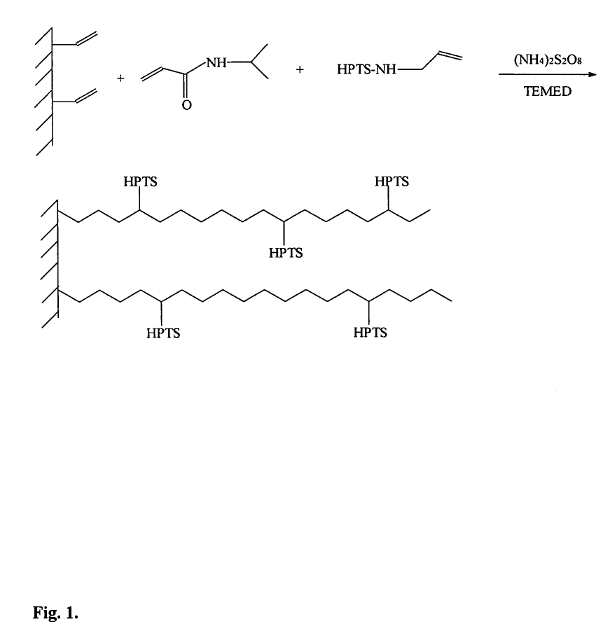

A schematic illustration of preparation of an optical sensor in accordance with the invention is shown in FIG. 1. An HPTS conjugate is first prepared. Suitable conjugates include but are not limited to conjugates of HPTS and an unsaturated alkyl or aromatic amine. Examples of such amines include, but are not limited to, allylamine, methallylamine, 4-aminostyrene, and vinylaniline. Most preferably, the conjugate is an HPTS-allylamine conjugate. This conjugate is copolymerized with an acrylamide onto a polyvinyl alcohol (PVA) polymer membrane modified to contain an unsaturated group such as vinyl group. Suitable acrylamides are acrylamide and N-isopropylacrylamide. A clear polymer sheet with the required fluorescence properties is obtained. The sheet can be used directly as a planar optode or portions used in fiber optic application. A polyester transparency sheet, for example, can be used as an underlying support for the fluorescent polymer layer. Any suitable material which is insoluble and transparent can be used as an underlying support material.

Preparation of pH Sensor Foil

Preparation of HPTS Conjugate

1. Preparation of HPTS-Sulfonyl Chloride.

Mix 100 mg HPTS with 1 gram PCl₅ in a 4-mL vial and allow the mixture to stand for 1 hour at room temperature. Transfer the mixture into an agate mortar and grind for 5 minutes under a hood. Extract the mixture twice with 10 mL acetone. Combine the extract solutions and filter.

2. Preparation of HPTS-Allylamine Conjugate.

Dissolve 30 μl of allylamine or other unsaturated alkyl or aromatic amine such as methallylamine, 4-aminostyrene, and vinylaniline etc. in 2 mL acetone. Gently drop the solvent mixture into the HPTS-sulfonyl chloride solution at 0° C. while stirring. Adjust the pH of the reaction solution to 8 using 2 M NaOH solution, and allow the mixture to react overnight at 0° C. while stirring. Remove the solvent under vacuum and save the residue for further reaction.

Preparation of Polyvinyl Alcohol Membrane with Vinyl Group on the Surface.

Add 10 mL of 4.2% polyvinyl alcohol, 1.0 mL of 2% allyl alcohol or other unsaturated alkyl alcohol or amine such as 3-butene-1-OH, methallylalcohol, allylamine etc., 1.2 mL of 5% glutaraldehyde and 1 mL of 4 M HCl into a 20-mL vial. Stir the mixture and then spread it on the surface of 300 cm² support transparency film (polyester). Keep the film level for several hours to dry the polymer membrane.

Preparation of Optode.

Dissolve the residue obtained in step 2 in 60 mL water. Then add 226 mg N-isopropylacrylamide or acrylamide, 20 mg (NH₄)₂S₂O₈, and 20 μl of N,N,N′,N′,-tetramethyl-ethylenediamine (TEMED). Mount (suspend) the polyvinyl alcohol membrane obtained above in a thin plastic tank and add the polymerization mixture. Allow the co-polymerization to occur for 2 hours at room temperature. Remove the membrane and wash with water. Place the membrane into pH 9 water solution overnight to remove any remaining free HPTS totally. The resulting fluorescent sheet may be stored dry or in water at room temperature.

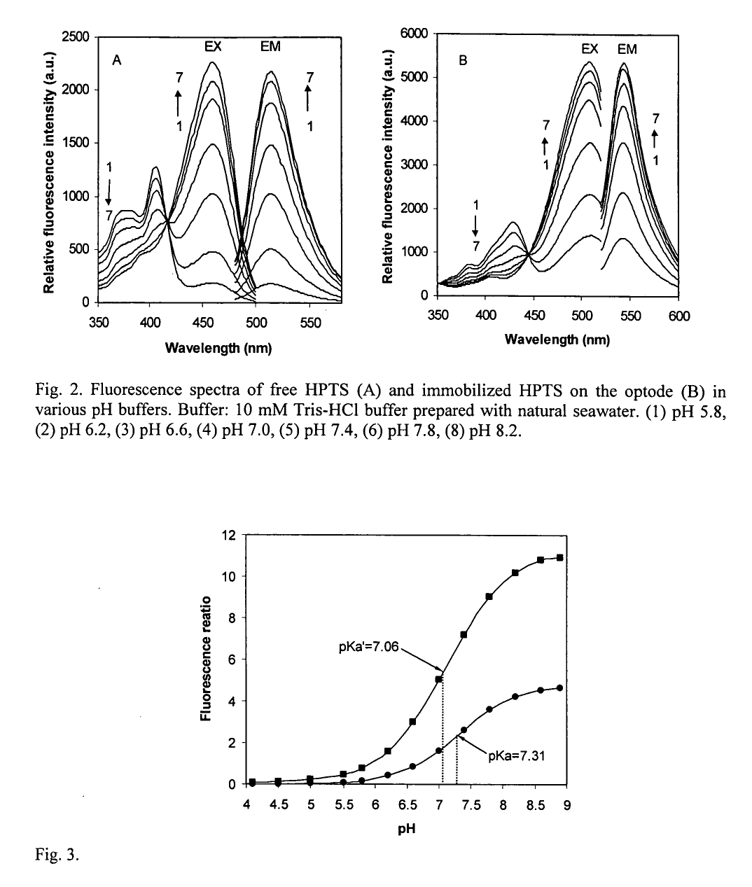

The fluorescence spectra of the immobilized HPTS in various seawater pH buffers are shown in FIG. 2 (B). Compared with the fluorescence spectra of free HPTS shown in FIG. 2 (A), the immobilized HPTS shows two similar excitation bands but is red shifted to 428 (acidic form) and 506 nm (basic form) with an isosbestic point at 444 nm. The fluorescence emission peak maximum is also shifted from 515 nm to 540 nm. The relative response behavior of fluorescence excitation and emission spectra of immobilized HPTS were virtually the same as those of free HPTS as a function of pH change. The large red-shifts for both excitation and emission bands are helpful to reduce the interferences from scattered light.

FIG. 3 shows the responses of the excitation fluorescence ratio of the sensor optode prepared above (squares) and free HPTS (circles) in various pH buffer solutions. The fluorescence ratio of the optode is the ratio of intensity of at 506 nm to that at 428 nm. The fluorescence intensity of the free HPTS is the ratio of intensity at 460 nm to that at 406 nm. As can be seen from FIG. 3, the ratio of excitation at of at 506 nm to that at 428 nm with emission at 540 is sensitive to pH change in the range of 5.5 to 8.6. The immobilized HPTS in the optode shows even higher sensitivity than free HPTS versus pH because of the larger calibration slope between pH 5.5 and 8.6. The calibration has a classic sigmoidal response to pH change with an approximately linear response from pH 6.2 to 7.8. A stable response to changes in pH was obtained at an average of approximately two minutes. The response slope is slightly reduced when the pH value is higher than 7.8. Other outstanding features of the fluorosensor include rapid response time (approximately 2 minutes), complete reversibility, high reproducibility and stability, and inertness to dissolved oxygen and temperature.

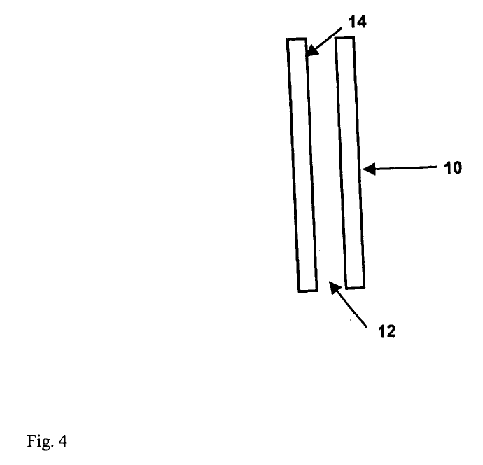

An embodiment of a schematic illustration of a thin-film pH standard apparatus in accordance with the invention is shown in FIG. 4. An insoluble and transparent material forms a support 10. A surface tension film 12 of a pH standard solution is applied to the support 10 and a sensor material 14 covers the standard solution such that sensing surface faces the standard solution 12. This results in a thin transparent sandwich of support, film of entrapped standard solution and sensor material. Typically, the sandwich has a total thickness of about 280 μm but any suitable thin film thickness can be utilized. Preferably, the width of the apparatus is less than 0.5 cm.

Suitable support materials include, but are not limited to, a polyester which is transparent, e.g., Mylar sheet. The pH standard solution is selected on the basis of the preferred pH reference scale for a given application. For example, some reference scales include but are not limited to the NIST (National Institute of Science & Technology) pH low ionic strength buffer scale, Hanssen seawater H⁺ activity scale and seawater total H⁺ concentration scale. A separate pH standard apparatus can also be prepared for each of a range of standard pH solution, for example, pH 6.0, 6.4, 6.8, 7.2, 7.6 and 8.0.

The thin-film pH standard apparatus of the invention is stable at room temperature and can be stored in a refrigerator for at least a year. The thin-film pH standard apparatus can be imaged directly at the same site or surface and condition where the pH is to be determined using an optical sensor and thus provides for in situ standardization of the optical sensor. The thin-film standard apparatus has been successfully used under water at the sea floor.

Preparation of Thin-Film pH Standard Apparatus

A 2×10 cm strip of a 125 μm thick of Mylar sheet is covered with a surface tension film of a buffer solution (Hanssen pH scale) applied with pH measurements in marine environments. A 2×10 cm sensor optode as prepared above is place over the buffer solution with sensing surface facing the solution to form a sandwich. The edges are sealed with Teflon tape or by using a heat sealer.

The thin-film pH standard apparatus can be fabricated either individually or in a serial array and can have any planar dimension or be cut to an arbitrary shape which is suitable for the measurement environment. For example, a series of pH standard thin film strips each having a rectangular size 0.5×2 cm or each having a circular diameter 0.5 cm can be placed in proximity to a target location for which pH is to be determined for simultaneous standardardization within the imaged plane.

Although preferred embodiments are specifically illustrated and described herein above, it will be appreciated that many modifications and variations of the present invention are possible in light of the above teachings and within the purview of the appended claims without departing from the spirit and intended scope of the invention.

We claim:

1. An optical sensor comprising
(a) a transparent support material, and
(b) a copolymer comprising a water-soluble portion conjugated to pyrenetrisulphonate wherein the copolymer has one end attached to the transparent support material.

2. An optical sensor according to claim 1 wherein the pyrenetrisulphonate is 8-hydroxyl-1,3,6-pyrenetrisulphonate.

3. An optical sensor according to claim 1 wherein the copolymer is prepared by the process comprising copolymerizing an acrylamide and the water-soluble portion conjugated to pyrenetrisulphonate.

4. An optical sensor according to claim 3 copolymerizing at least one selected from the group consisting of acrylamide and N-isopropylacrylamide and the water-soluble portion conjugated to pyrenetrisulphonate.

5. An optical sensor according to claim 4 wherein the at least one selected from the group consisting of acrylamide and N-isopropylacrylamide is N-isopropylacrylamide.

6. An optical sensor according to claim 1 wherein the water-soluble portion conjugate a pyrenetrisulphonate is prepared by reacting a pyrenetrisulphonyl chloride and at least one selected from the group consisting of an unsaturated alkyl amine and an aromatic amine.

7. An optical sensor according to claim 6 wherein the at least one selected from the group consisting of an unsaturated alkyl amine and an aromatic amine is selected from the group consisting of methallylamine, allylamine, 4-aminostyrene and vinylaniline.

8. An optical sensor according to claim 7 wherein the at least one selected from the group consisting of an unsaturated alkyl amine and an aromatic amine is allylamine.

9. A method of preparing an optical sensor comprising:
(a) conjugating a pyrenetrisulphonyl chloride and a water soluble material to form a conjugate, and
(b) copolymerizing the conjugate and an acrylamide wherein a copolymer is formed, and wherein one end of the copolymer is attached to support.

10. A method according to claim 9 wherein the support comprises a polymer membrane.

11. A method according to claim 10 comprising preparing the polymer membrane by a process comprising mixing at least one selected from the group consisting of an unsaturated alkyl alcohol and an unsaturated alkyl amine, polyvinyl alcohol, HCl and gluteraldehyde to form a mixture and spreading the mixture on a transparent support.

12. A method according to claim 11 wherein the at least one selected from the group consisting of an unsaturated alkyl alcohol and an unsaturated alkyl amine is selected from the group consisting of allylalcohol, 3-butene-1-OH, methallylalcohol and allylamine.

13. A method according to claim 12 wherein the at least one selected from the group consisting of an unsaturated alkyl alcohol and an unsaturated alkyl amine is allylalcohol.

14. A method according to claim 9 comprising conjugating 8-hydroxy-1,3,6-pyrenetrisulphonyl chloride and a water-soluble material selected from the group consisting of an unsaturated alkyl amine and an aromatic amine.

15. A method according to claim 9 wherein the water-soluble material is at least one selected from the group consisting of methallylamine, allylamine, 4-aminostyrene and vinylaniline.

16. A method according to claim 9 wherein the water-soluble material is allylamine.

17. A method according to claim 9 comprising copolymerizing the conjugate and at least one selected from the group consisting of acrylamide and N-isopropylacrylamide.

18. A method according to claim 9 wherein the acrylamide is N-isopropylacrylamide.

19. A method of determining the pH of a sample comprising:
(a) providing an optical sensor foil comprising (i) a transparent support material, and (ii) a copolymer comprising a water soluble portion conjugated to a pyrenetrisulphonate wherein the copolymer has one end attached to the transparent support material, and
(b) contacting the sample with the optical sensor foil,
(c) obtaining the fluorescence intensity of the sensor foil in the sample, and
(d) determining the pH of the sample from a fluorescence intensity ratio.

20. A method of determining the pH of a sample according to claim 19 wherein the pyrenetrisulphonate is 8-hydroxy-1,3,6-pyrenetrisulphonate.

21. A method of determining the pH of a sample according to claim 19 wherein the copolymer is prepared by a process comprising conjugating pyrenetrisulphonyl chloride and at least one selected from the group consisting of an unsaturated alkyl amine and an aromatic amine.

22. A method according to claim 21 wherein the water-soluble portion conjugated to a pyrenetrisulphonate is pyrenetrisulphonyl chloride conjugated to at least one selected from the group consisting of methyallylamine, allylamine, 4-aminostyrene and vinylaniline.

23. A method according to claim 19 wherein the water-soluble portion conjugated to a pyrenetrisulphonate is pyrenetrisulphonyl chloride conjugated to allylamine.

24. A method according to claim 19 comprising determining the pH of at least one sample selected from the group consisting of seawater, sediment, and soil.

25. A thin-film pH standard apparatus comprising
(a) a transparent support material,
(b) a film of a pH standard solution above the support material; and
(c) an optical sensor material having a sensor surface facing the standard solution

26. A method according to claim 19 further comprising:
(e) providing a thin-film pH standard apparatus comprising a transparent support material, a film of a pH standard solution and a second optical sensor foil having the composition of the sensor foil of (a) wherein the sensor surface of the foil faces the standard solution,
(f) contacting the thin-film pH standard apparatus with the sample,
(g) obtaining the fluorescence intensity of the second optical sensor foil in the pH standard apparatus,
(h) correlating the fluorescence intensity ratio of the second optical foil in pH standard apparatus with pH, and
(i) comparing the fluorescence intensity ratio of the pH sensor foil with the fluorescence intensity ratio of the second optical foil to determine pH of the sample.
